(19) United States
(12) Patent Application Publication
(10) Pub. No.: US 2010/0138625 A1
(43) Pub. Date: Jun. 3, 2010

(54) RECORDING MEDIUM STORING UPDATE PROCESSING PROGRAM FOR STORAGE SYSTEM, UPDATE PROCESSING METHOD, AND STORAGE SYSTEM

(75) Inventors: Yasuo Noguchi, Kawasaki (JP); Kosuke Uchida, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/621,648

(22) Filed: Nov. 19, 2009

(30) Foreign Application Priority Data
Nov. 28, 2008 (JP) 2008-304197

(51) Int. Cl. G06F 12/00; G06F 9/44

(52) U.S. Cl. 711/167; 712/225; 711/E12.001; 711/154; 712/E09.033

(57) ABSTRACT

A reading and writing control unit has a synchronous mode for directly writing write data in storage devices and an asynchronous mode for accumulating the write data in a cache memory and writing the accumulated write data in the storage devices. A synchronization and asynchronization instructing unit instructs whether the data writing is to be performed in the synchronous mode and the asynchronous mode. A process control unit switches the reading and writing control unit, which is set in the asynchronous mode, to the synchronous mode. The process control unit issues an end instruction to cause the process to end service processing in a state in which the write data output by the process is directly written in the storage device. The process control unit starts service processing of the new process after the process ends the service processing and notifies an end result when the processing ends.

### CROSS-REFERENCE TO RELATED APPLICATIONS

This application is based upon and claims the benefit of priority of the prior Japanese Patent Application No. 2008-304197, filed on Nov. 28, 2008, the entire contents of which are incorporated herein by reference.

### FIELD

The present invention relates to update processing for a storage system.

### BACKGROUND

As a storage system, there is a distributed multi-node storage in which a plurality of storage nodes are distributedly arranged on a network and caused to cooperate with one another to improve performance and reliability. In the multi-node storage, a control node manages the storage nodes. Therefore, each of the storage nodes periodically transmits, via a transmission function unit, a survival signal indicating that the storage node is operating. This survival signal is referred to as a heartbeat. The control node monitors the heartbeat transmitted from the storage node. When the heartbeat from the storage node is interrupted, the control node performs recovery processing. See, for example, WO2004/104845.

In the multi-node storage, for maintenance and the like, it is necessary to update a process installed in the storage node without stopping the system during operation. FIG. 14 is a diagram illustrating a prior art procedure of a process update for the multi-node storage.

The multi-node storage of an example illustrated in FIG. 14 includes a control node 90 that performs recovery processing and the like and disk nodes 91, 92, and 93 that distributedly store data. Each of the disk nodes 91, 92, and 93 transmits a heartbeat (in the figure, “HB”) at a fixed period. The control node 90 receives heartbeats from the disk nodes 91, 92, and 93 and detects states of the disk nodes 91, 92, and 93.

A process in the past for performing update of the disk node 93 during operation is explained. To update a process, it is necessary to restart the disk node 93. Therefore, the control node 90 instructs the disk node 93 to end an old process. The disk node 93 performs old process end processing 931. Subsequently, the control node 90 issues an instruction for a restart in a new process. The disk node 93 performs new process restart processing 932. While this processing is performed, the disk node 93 cannot transmit the heartbeat. Other apparatuses cannot access the disk node 93. After the new process restart processing 932 ends, the transmission of the heartbeat is resumed and the disk node 93 returns to a normal state.

On the other hand, during the update of the disk node 93, the control node 90 may receive heartbeats from the disk nodes 91 and 92. However, the control node 90 cannot receive the heartbeat from the disk node 93 in which update processing is started. When this HB interruption period of the disk node 93 exceeds a fixed time, the control node 90 regards the disk node 93 is in failure and performs recovery processing 901.

However, in the multi-node storage in the past, update work for a process during operation is not easy.

As illustrated in FIG. 14, to update a process, restart of a disk node is necessary. During the restart, a heartbeat (HB) is interrupted. The disk node cannot respond to accesses from other apparatuses. Further, when a heartbeat interruption period of the disk node exceeds the fixed time, it is determined that the disk node fails. Recovery of the disk node is performed. Therefore, it is necessary to reduce time required for the update as much as possible.

However, before starting the new process, the disk node 93 has to execute the old process end processing 931 and the new process restart processing 932. In the old process end processing 931, processing for writing data, which is temporarily stored in a cache memory, on a disk and synchronizing the data is performed by an OS (Operating System). In this synchronization processing, processing time increases according to an amount of data remaining in the cache memory. When a large amount of data is left in the cache memory, an extremely long time is required. In the new process restart processing 932, it is necessary to read metadata concerning the data distributedly arranged in the disk nodes. The metadata is also distributedly arranged in the other disk nodes. It takes time to read the metadata. In this way, since there are factors of long processing time in both the old process end processing 931 and the new process restart processing 932, it is not easy to reduce the time for the update. As a result, the disk node that is performing the update cannot be prevented from being regarded as being in failure.

Further, when two or more disk nodes are simultaneously determined as being in failure, the multi-node storage is shut down. Therefore, the two or more disk nodes cannot be simultaneously updated and have to be sequentially updated. Since the disk nodes are updated one by one in this way, enormous time is required until the entire system is updated.

A technique disclosed herein has been devised in view of such problems. It is an object of the present invention to provide a technique concerning update processing for a multi-node storage system that may reduce time required for update of a process in operation.

### SUMMARY

A storage system stores data distributedly among a plurality of storage devices. A process control unit controls operation of a process that is executing specific service processing and a new process, accumulates, when an update is requested, write data in the storage devices in a cache memory while the process is executing the service processing, and issues an instruction for switching an operation mode of a reading and writing control unit, for which an asynchronous mode for writing the accumulated data in the storage device at a specific timing is selected, to a synchronous mode for directly writing the write data in the storage device. A synchronization and asynchronization instructing unit issues, according to the instruction of the process control unit, an instruction for switching the asynchronous mode to the synchronous mode to the reading and writing control unit that writes, in the storage device, the write data output by the process or the new process in the synchronous mode or the asynchronous mode. The process control unit issues an end instruction to the process and causes the process to end the service processing in a state in which the reading and writing control unit operates in the synchronous mode and the write data of the process is directly written in the storage device. The process control unit starts service processing of the new process after the process ends the service processing.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 illustrates an overview of an embodiment of the present invention;

FIG. 2 illustrates a configuration example of a multi-node storage according to the embodiment;

FIG. 3 illustrates a hardware configuration example of a disk node;

FIG. 4 illustrates software configurations of units that perform update processing in the multi-node storage;

FIG. 5 illustrates an example of a management table;

FIG. 6A illustrates an example of the management table before command issuance;

FIG. 6B illustrates an example of the management table after the command issuance;

FIG. 6C illustrates an example of the management table during result reception after the command issuance;

FIG. 6D illustrates an example of the management table after command result reception;

FIG. 6E illustrates an example of the management table after the command result reception (including NG);

FIG. 7 illustrates an operation sequence of update processing (a procedure up to switching to a synchronization mode);

FIG. 8 illustrates the operation sequence of the update processing (a procedure up to switching to a new process);

FIG. 9 illustrates an operation sequence at the time when the start of the new process fails;

FIG. 10 illustrates an operation sequence at the time when synchronization of a process fails;

FIG. 11 illustrates an operation sequence at the time when the stop of service of a process fails;

FIG. 12 is a flowchart illustrating an update processing procedure of a management node;

FIG. 13 is a flowchart illustrating a procedure of rollback processing; and

FIG. 14 illustrates a prior art procedure of process update of a multi-node storage.

### DESCRIPTION OF EMBODIMENTS

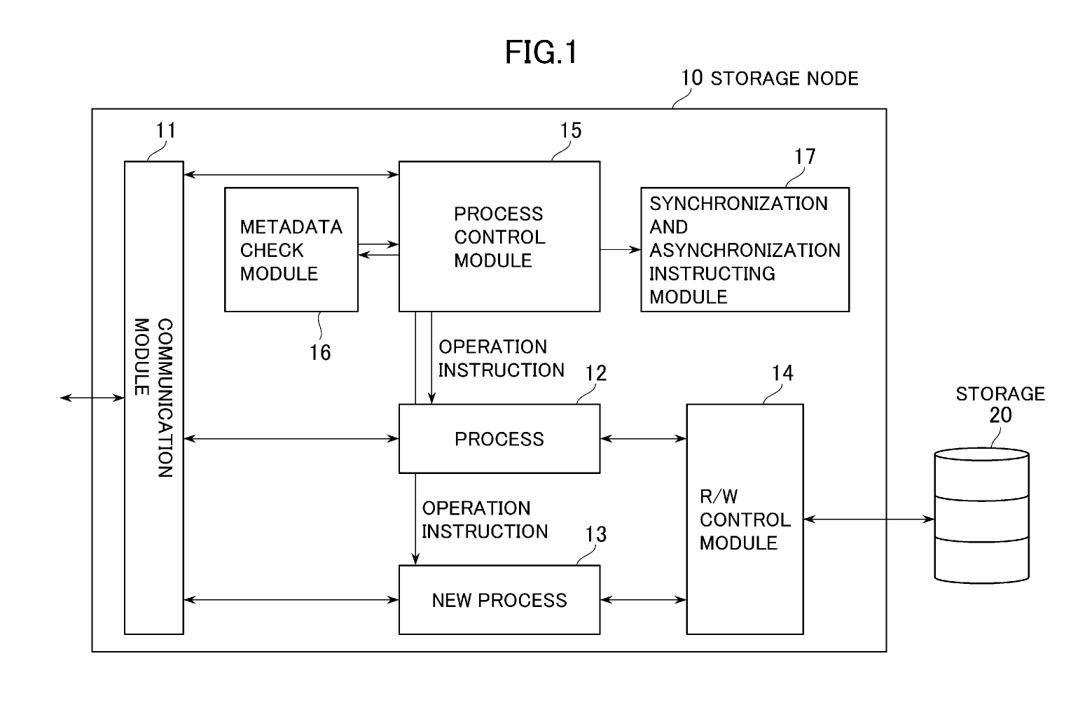

FIG. 1 illustrates an overview of an embodiment of the present invention. The figure illustrates one of a plurality of storage nodes included in a storage system.

A storage node 10 is connected to a storage 20 that stores data. The storage node 10 manages access to the data in the storage 20 according to a request from an access node or a control node input via a network.

This storage system has a virtual disk called a “logical volume.” This logical volume is divided into units (hereinafter referred to as “segments”) of a specific size. Data of the segments is distributedly arranged among a plurality of storage nodes. A data storage area of the storage 20 is divided into specific units called “slices.” The segments are allocated to the slices. Management information in which identification information of logical segments, which is obtained by dividing the virtual logical volume, and slices, which are obtained by dividing, into segment units, an actual data storage area of a storage device associated with the logical segments, are associated with each other is called “metadata.” Information concerning the segments allocated to the slices (addresses on a logical disk of the segments, etc.) and the like are described in the metadata. The metadata is managed together with segment data.

The storage node 10 includes a communication module 11 connected to the network, a process 12 in operation, a new process 13 after an update, a reading and writing control module (hereinafter referred to as “R/W control module”) 14 that controls reading from and writing to the storage 20, a process control module 15 for controlling the operation of processes, a metadata check module 16 for checking a change of metadata, and a synchronization and asynchronization instructing module 17 for instructing an operation mode for writing to the storage. The respective processing modules realize functions thereof when a computer executes computer programs that describe the processing. In particular, the process control module 15, the metadata check module 16, and the synchronization and asynchronization instructing module 17 realize processing functions thereof when the computer executes an update processing program.

The communication module 11 controls communication between the storage node 10 and a control node, an access node, and other storage nodes connected thereto via a network not illustrated in the figure.

The process 12 is executing a predetermined service processing in a process currently in operation.

The new process 13 is a process for providing a service in stead of the process 12 after an update and has the same function as the process 12.

The R/W control module 14 receives a data readout request or a data writing request from the process 12 and/or the new process 13 and controls data readout processing from the storage 20 or data writing processing to the storage 20. The data writing processing includes a synchronous mode and an asynchronous mode. In the synchronous mode, when the data writing request is received, the R/W control module 14 directly performs writing to the storage 20 and returns a response of writing completion. On the other hand, in the asynchronous mode, when the data writing request is received, the R/W control module 14 accumulates the data in a cache memory and returns a response of writing completion. The R/W control module 14 writes the data accumulated in the cache memory at a specific timing in the storage 20. In normal processing, in order to improve response performance, writing processing is performed in the asynchronous mode.

The process control module 15 controls the operation of a process under management based on, for example, an instruction from a management node input via the communication module 11. In an update, the process control module 15 starts the new process 13 in a state in which the service is stopped. The process control module 15 instructs the synchronization and asynchronization instructing module 17 to set the R/W control module 14 in the synchronous mode in a state in which the process 12 is performing service processing. The process control module 15 instructs the process 12 to perform end processing and ends the process 12 in a state in which the process 12 is operating in the synchronous mode. Thereafter, the process control module 15 starts the service of the new process 13. At this point, the process control module 15 instructs the synchronization and asynchronization instructing module 17 to reset the R/W control module 14 to the asynchronous mode.

The metadata check module 16 performs metadata change check of its own node according to an instruction from the process control module 15. The metadata check module 16 compares at least metadata before the start of the update processing and metadata at the end of the update processing. In this way, the metadata check module 16 determines whether or not the metadata is changed before and/or after the update processing and notifies the process control module 15 of a determination result.

The synchronization and asynchronization instructing module 17 issues a switching command for the synchronous mode and the asynchronous mode to the R/W control module 14 according to an instruction from the process control module 15.

When a process is operating normally, a heartbeat is transmitted to other apparatuses by a heartbeat transmitting module not illustrated in the figure. The heartbeat is a survival signal indicating a state of the own apparatus and is periodically transmitted.

An update operation for a process by the storage node 10 having such a configuration will be explained now. Currently, the process 12 is executing a service processing. The R/W control module 14 is operating in the asynchronous mode. By setting the R/W control module 14 in the asynchronous mode, a response time at the time of writing may be reduced.

A program of the new process 13 to be updated is loaded to storage module in advance.

The process control module 15 reads out the metadata of other apparatuses via the metadata check module 16 and starts the new process 13 in a state in which the service is stopped. The new process 13 reads in metadata and performs start processing, although service processing is stopped. The metadata check module 16 stores the metadata at this point. The process control module 15 instructs the synchronization and asynchronization instructing module 17 to set the R/W control module 14 in the synchronous mode. Consequently, when the process 12 issues a data writing request, data is immediately written in the storage 20. Subsequently, the process control module 15 instructs the process 12 to end the processing. Since the R/W control module 14 is operating in the synchronous mode, synchronous processing for writing data of the cache memory in the storage 20 is unnecessary. Therefore, the process 12 is able to complete the end processing in a short time. After the process 12 is ended, the metadata check module 16 checks whether the metadata is changed. The metadata check module 16 collects metadata again and compares the metadata with the metadata at the time when the new process 13 started. The comparison may be performed every time processing is performed. When the metadata is not changed, the process control module 15 restarts the new process 13. Since the metadata reading during start is completed, the new process 13 completes restart processing in a short time and starts service processing. On the other hand, when the metadata is changed, the process control module 15 suspends the update and resets the process 12 to a state before the update started (the state in which the process 12 is performing the service processing in the asynchronous mode). If desired, the process control module 15 performs update processing in the procedure explained above again with new metadata.

As explained above, with the storage node 10, it is unnecessary to perform data synchronization processing that extends the end processing time for the process 12 during the update from the process 12 to the new process 13. It is also unnecessary to perform metadata readout processing that extends the time required for restart of the new process 13. Consequently, the time required for the update may be reduced. As a result, it is possible to start, during the restart, transmission of a heartbeat before the control node determines a failure. It is possible to reduce recovery processing.

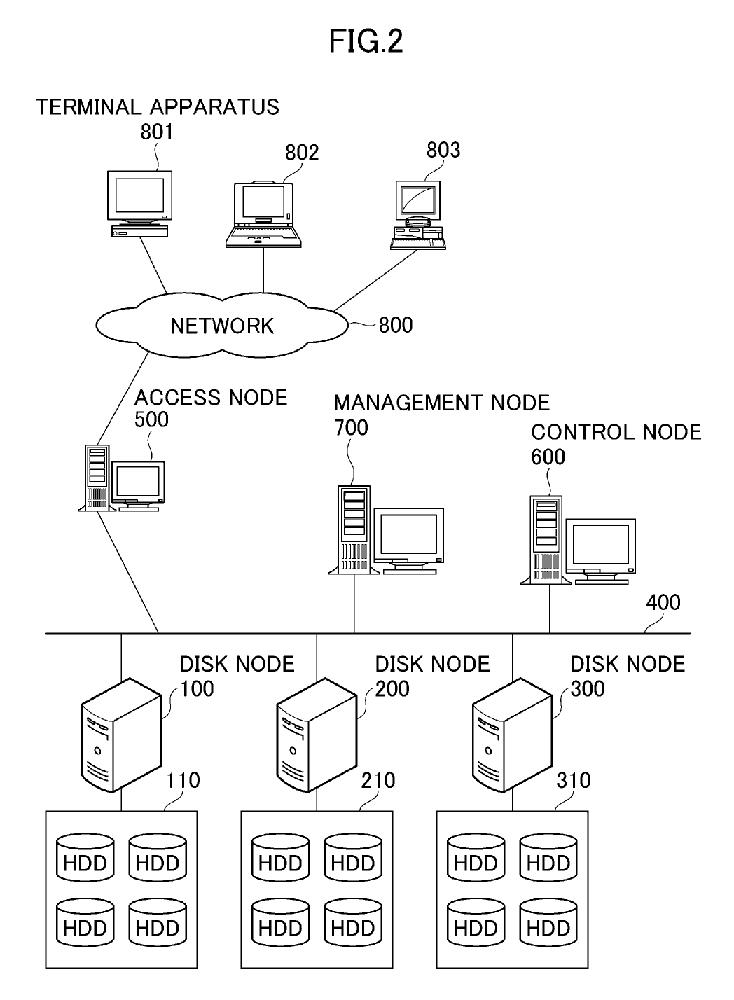

The embodiment of the present invention is explained below in detail. FIG. 2 illustrates a configuration example of a multi-node storage according to this embodiment.

In the multi-node storage, a plurality of disk nodes 100, 200, and 300, an access node 500, a control node 600, and a management node 700 are connected to one another via a network 400.

A disk 110 is connected to the disk node 100, a disk 210 is connected to the disk node 200, and a disk 310 is connected to the disk node 300. A plurality of hard disk devices (HDDs) are mounted on the disk 110. Configurations of the disks 210 and 310 are the same. The disk nodes 100, 200, and 300 may be, for example, computers having an architecture called IA (Intel Architecture). The disk nodes 100, 200, and 300 manage data stored in the disks 110, 210, and 310 connected thereto and provide terminal apparatuses 801, 802, and 803 with the managed data through the access node 500. The disk nodes 100, 200, and 300 may also manage data having redundancy. In this case, the same data is managed in at least two disk nodes. In this embodiment, the storage node that performs the update processing illustrated in FIG. 1 is provided as the disk nodes 100, 200, and/or 300.

The plurality of terminal apparatuses 801, 802, and 803 are connected to the access node 500 via a network 800. The access node 500 recognizes storage locations of the data managed by the respective disk nodes 100, 200, and 300. The access node 500 performs data access to the disk nodes 100, 200, and/or 300 in response to requests from the terminal apparatuses 801, 802, and/or 803.

The control node 600 manages the disk nodes 100, 200, and/or 300. For example, the control node 600 monitors heartbeats transmitted from the disk nodes 100, 200, and/or 300 and, when a failure is detected, performs recovery processing.

The management node 700 manages the entire system of the multi-node storage. For example, the management node 700 manages update processing for all the disk nodes 100, 200, and 300 according to, for example, an update command from an administrator.

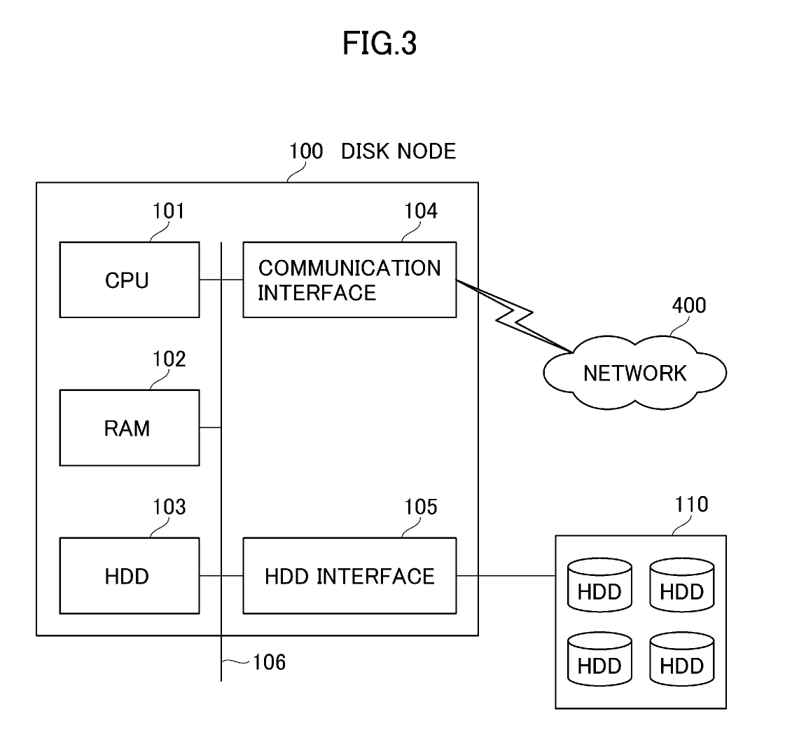

FIG. 3 illustrates a hardware configuration example of a disk node. The entire disk node 100 is controlled by a CPU (Central Processing Unit) 101. A RAM (Random Access Memory) 102, a HDD 103, a communication interface 104, and a HDD interface 105 are connected to the CPU 101 via a bus 106.

At least a part of an OS and/or application programs, which are executed by the CPU 101, is temporarily stored in the RAM 102. Various data for processing by the CPU 101 is stored in the RAM 102. The OS and the application programs are stored in the HDD 103. The communication interface 104 is connected to the network 400. The communication interface 104 transmits data to and receives data from other computers included in the multi-node storage such as other disk nodes, the access node 500, the control node 600, and the management node 700 via the network 400. The HDD interface 105 performs access processing to the HDDs included in the disk 110.

With the hardware configuration explained above, processing functions according to this embodiment may be realized. The disk node 100 is illustrated in FIG. 3. However, the other disk nodes 200 and 300 are realized by the same hardware configuration.

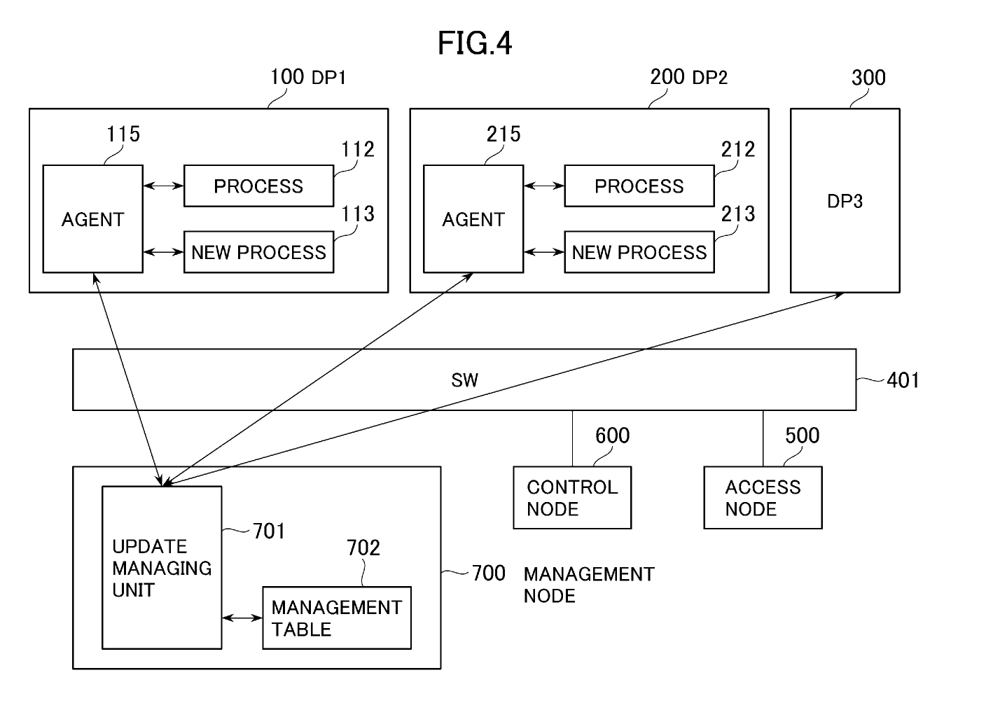

Units that perform the update processing in the multi-node storage will be explained. FIG. 4 illustrates software configurations of the units that perform the update processing in the multi-node storage.

The disk nodes 100, 200, and 300 perform data exchange with the access node 500, the control node 600, and the management node 700 via a switch (SW) 401. Update management for the disk nodes 100, 200, and 300 is performed by the management node 700.

The disk node 100 includes the process 112, the new process 113, and an agent 115 that performs the update processing. An ID “DP1” is given to the disk node 100. Similarly, the disk node 200 includes a process 212, a new process 213, and an agent 215. An ID “DP2” is given to the disk node 200.

The disk node 300 has the same configuration. An ID “DP3” is given to the disk node 300.

The processes 112 and 212 are processes that are currently performing service processing in a process before an update. The new processes 113 and 213 are processes after the update. The processes 112 and 212 and the new processes 113 and 213 operate according to instructions of the agents 115 and 215 and are in a state in which no processing is executed, a state in which processing other than the service processing is executed, or a state in which the service processing is executed. For example, according to a process start command, the processes 112 and 212 and the new processes 113 and 213 transition from the state in which no processing is executed to the state in which the processing other than the service processing is executed. According to a service start command, the processes 112 and 212 and the new processes 113 and 213 transition to the state in which the service processing is executed. According to a service stop command, the processes 112 and 212 and the new processes 113 and 213 transition from the state in which the service processing is executed to the state in which the processing other than the service processing is executed. According to an end command, the processes 112 and 212 and the new processes 113 and 213 end all processing and transition to the state in which no processing is executed.

The agents 115 and 215 update the processes 112 and 212 to the new process 113 and 213 according to an instruction from the management node 700. Therefore, the agents 115 and 215 have the functions of the process control module 15, the metadata check module 16, and the synchronization and asynchronization instructing module 17. In most cases, the OS manages whether access to the disk 110 is performed in the synchronous mode or in the asynchronous mode. Usually, commands for switching a mode are prepared in the OS. The agents 115 and 215 output such commands to the OS to perform switching of the synchronous and asynchronous modes. For example, the agents 115 and 215 cause switching from the asynchronous mode to the synchronous mode by outputting commands in the order of temporarily stopping access reception, closing a device file, opening the device file in the synchronous mode, and resuming the access reception. Similarly, the agents 115 and 215 cause switching from the synchronous mode to the asynchronous mode by outputting commands in the order of temporarily stopping access reception, closing a device file, opening the device file in the asynchronous mode, and resuming the access reception.

The management node 700 includes an update managing unit 701 that manages updates, and a management table 702. In the management table 702, update management information for managing update progress states of the disk nodes 100, 200, and 300 under management is set. For example, issued commands and results of the commands are managed for each of the disk nodes. The update managing unit 701 performs communication with the agent 115 of the disk node 100, the agent 215 of the disk node 200, and an agent of the disk node 300 not illustrated in the figure based on the management table 702, and simultaneously processes the update of the disk nodes under management.

Therefore, the update managing unit 701 sequentially outputs instructions conforming to an order of the update as commands to the disk nodes 100, 200, and 300 as management target. For example, the update managing unit 701 outputs a command for instructing the start of a new process to the disk nodes 100, 200, and 300 under management. When responses of normal completions are obtained from all the disk nodes 100, 200, and 300, the update managing unit 701 outputs a command for instructing a change of the writing control to the synchronous mode to the disk nodes 100, 200, and 300. Similarly, the update managing unit 701 sequentially outputs commands for the end of a process, the service start of a new process, and the like. The agents of the disk nodes 100, 200, and 300 receive the commands and perform processing, whereby updates of all the disk nodes are performed at substantially the same time.

The simultaneous update processing by the management node 700 is explained below in detail. First, the management table 702 will be explained.

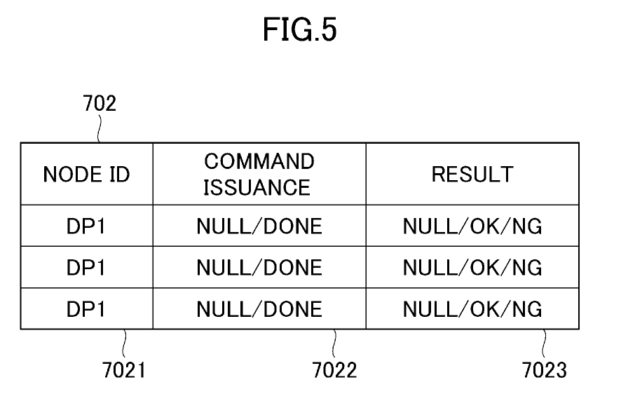

FIG. 5 illustrates an example of the management table.

In the management table 702, information items including a node ID 7021 column, a command issuance 7022 column, and a result 7023 column are registered as management information of disk nodes as management targets.

In the node ID 7021 column, identification information of the disk nodes as the management targets (IDs given to the disk nodes) are registered. For example, DP1 of the disk node 100, DP2 of the disk node 200, and DP3 of the disk node 300 are registered.

Issuance states of commands are registered in the command issuance 7022 column. For example, when a command is not output to the disk nodes 100, 200, and 300, NULL (which means “no command”) is registered. When a command is issued, DONE (which means “issued”) is registered in a space corresponding to the disk node to which the command is transmitted. A type of issued command may also be registered.

In the result 7023 column, processing results of the disk nodes 100, 200, and 300 are registered based on responses obtained from the disk nodes 100, 200, and 300 after the command issuance. Until the results are received, NULL is registered in the result 7023 column. When a response is received and a result of the response indicates normal completion, OK (which means “completed normally “) is registered in the result 7023 column. When a response is received and a result of the response does not indicate a normal completion, NG (which means “failure”) is registered in the result 7023 column.

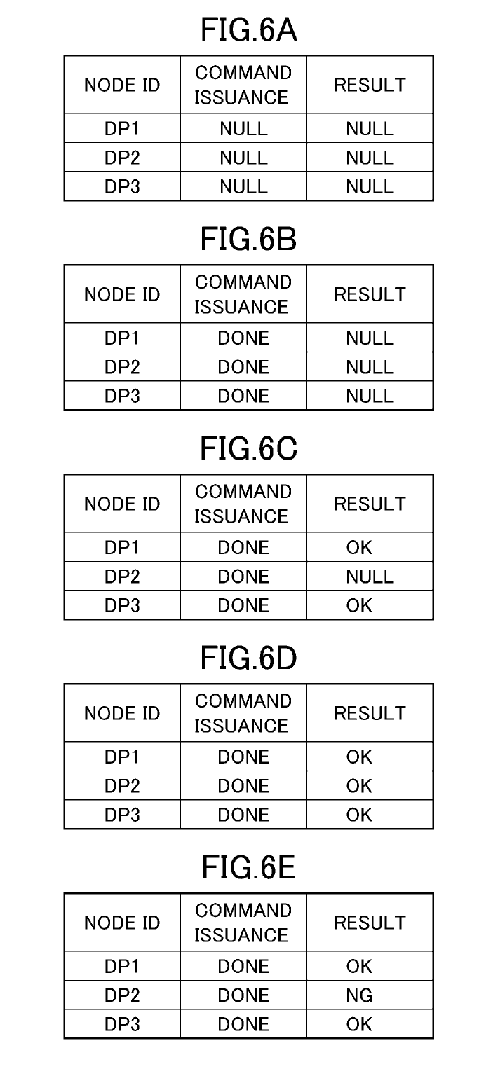

FIG. 6A illustrates a management table in a state before command issuance. FIG. 6B illustrates the management table in a state after the command issuance. FIG. 6C illustrates the management table in a state during result reception after the command issuance. FIG. 6D illustrates the management table in a state after command result reception. FIG. 6E illustrates the management table in a state after the command result reception (including NG).

(A) “Before the command issuance” is a state in which the command issuance 7022 is NULL for all the disk nodes (DP1, DP2, and DP3).

(B) “After the command issuance” is a state in which the command issuance 7022 is DONE for all the disk nodes (DP1, DP2, and DP3). In this way, the issuance of a command is performed at substantially the same time for the disk nodes as the management targets.

(C) “During the result reception after the command issuance” is a state in which responses of processing results from the disk nodes (DP1, DP2, and DP3) to which commands are issued are waiting. When the processing of the issued commands is completed, the disk nodes (DP1, DP2, and DP3) transmit results of the processing to the management node 700. In this example, responses from the disk nodes DP1 and DP3 are obtained and a response from the disk node DP2 is not obtained.

(D) “After the command result reception” is a state in which responses are obtained from all the disk nodes (DP1, DP2, and DP3). This example indicates that OK is obtained from all of the disk nodes DP1, DP2, and DP3.

(E) “After the command result reception (including NG)” is a state in which responses are obtained from all the disk nodes (DP1, DP2, and DP3) and NG is included in the responses. This example indicates that responses of OK are obtained from the disk nodes DP1 and DP3 and a response of NG is obtained from the disk node DP2.

The management node 700 carries out the update processing based on the management table 702.

Update processing operation and an update method of the multi-node storage having the configuration explained above are explained in detail below.

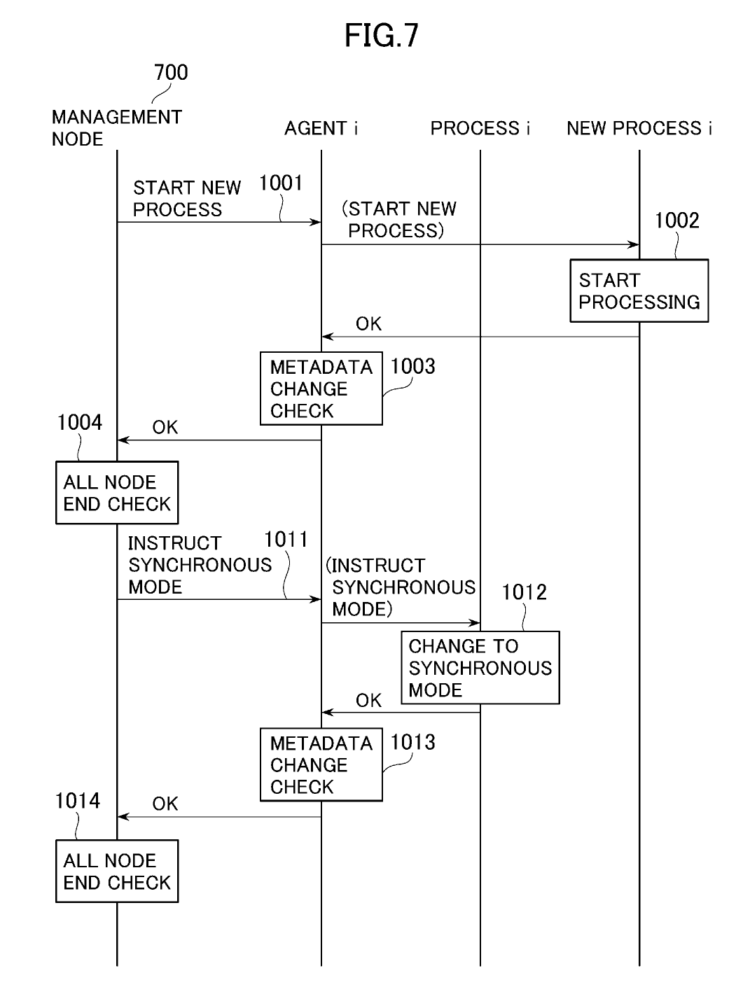

FIG. 7 illustrates an operation sequence of the update processing (a procedure up to switching to the synchronous mode). In an example illustrated in FIG. 7, all instructions from the management node 700 are successful. An agent i is an agent mounted on an arbitrary disk node. A process i represents a process in operation of the agent i. A new process i represents a new process of the agent i.

When an update command is issued to the management node 700 by a system administrator or the like, the processing is started. It is assumed that a computer program for the new process i is downloaded to disk nodes in advance.

The management node 700 outputs a new process start command (1001) to all the disk nodes it manages. The agent i that receives the command instructs the new process i to start a new process. Consequently, start processing (1002) is performed by the new process i. In the start processing (1002), the new process i is started in a state in which metadata is read and service processing is stopped. After the start processing ends and processing other than the service processing changes to an execution state, OK is returned to the agent i. When the start processing fails, NG is returned to the agent i. The agent i that receives OK performs a metadata change check (1003). In the metadata change check (1003), the agent i collects metadata and determines whether this metadata and metadata used in the start processing (1002) (metadata collected the previous time) are the same. When the metadata is not changed, the agent i returns a response of OK to the management node 700. When the metadata is changed, the agent i returns a response of NG to the management node 700. In subsequent metadata change checks, the same check is performed. In the following explanation, it is assumed that OK is returned. The management node 700 that receives OK from the agent i waits for responses from the other agents and checks whether or not all the nodes end normally (1004). When all the nodes complete the new process start normally, the management node 700 shifts the processing to the next procedure. When the start of the new process fails in a part of the nodes or a change of the metadata occurs, the management node 700 performs rollback processing. The rollback processing will be explained below.

When all the nodes complete the new process start normally, the management node 700 issues a synchronous mode command (1011). The agent i that receives the command instructs the process i to change the writing control to the synchronous mode. Consequently, a writing mode in the disk of the process i currently in operation is changed to the synchronous mode (1012). A response of OK for the change to the synchronous mode is returned to the agent i. When the change to the synchronous mode fails, a response of NG is returned to the agent i. The agent i that receives the OK response performs a metadata change check (1013). When the metadata is not changed, the agent i returns a response of OK to the management node 700. When the metadata is changed, the agent i returns a response of NG to the management node 700. In the following explanation, it is assumed that an OK response is returned. The management node 700 that receives the OK response from the agent i waits for responses from the other agents and checks whether all the nodes end normally (1014). When all the nodes complete the new process start normally, the management node 700 shifts the processing to the next procedure. When the synchronization of the process fails in a part of the nodes or a change of the metadata occurs, the management node 700 performs the rollback processing.

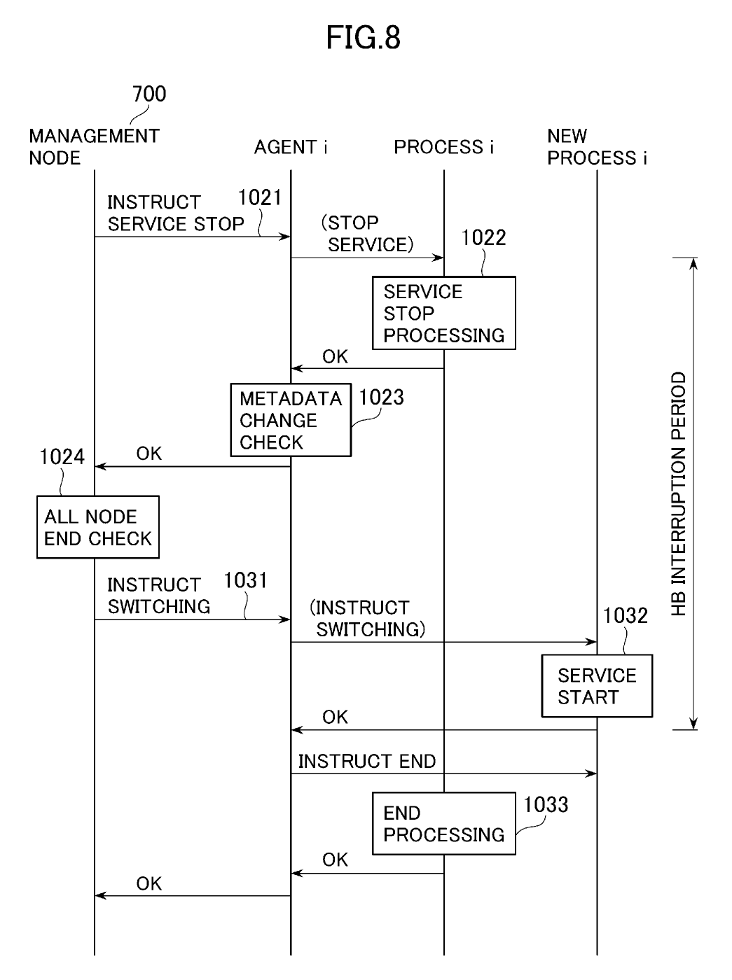

The operation procedure is explained with reference to FIG. 8. FIG. 8 illustrates the operation sequence of the update processing (a procedure up to switching to a new process).

When all the nodes complete the shift to the synchronous mode normally, the management node 700 issues a service stop command for the process i (1021). The agent i that receives the command instructs the process i to stop service. Consequently, the process i currently in operation performs service stop processing (1022) and stops the service. Along with the service stop, the transmission of the heartbeat is also stopped and a heartbeat (HB) interruption period is started. When the service stop of the process i is completed, a response of OK is returned to the agent i. When the service stop fails, a response of NG is returned to the agent i. The agent i that acquires the OK response performs metadata change check (1023). When the metadata is not changed, the agent i returns a response of OK to the management node 700. When the metadata is changed, the agent i returns a response of NG to the management node 700. In the following explanation, it is assumed that a response of OK is returned. The management node 700 that receives an OK response from the agent i waits for responses from the other agents and checks whether all the nodes end normally (1024). When all the nodes complete the service stop of the process i normally, the management node 700 shifts the processing to the next procedure. When the synchronization of the process fails in a part of the nodes or a change of the metadata occurs, the management node 700 performs the rollback processing.

When all the nodes complete the service stop processing of the process i normally, the management node 700 issues a switching command to the new process i (1031). The agent i that receives the command instructs the new process i to perform switching (start service). Consequently, the new process i, which currently stops the service processing, performs service start processing (1032) and starts service. Since the new process i has already started operation in the start processing 1002, the new process i may immediately start service processing. Simultaneously with the service start, the transmission of the heartbeat is resumed and the heartbeat (HB) interruption period ends. When the service start of the new process i is completed, a response of OK is returned to the agent i. When the service start fails, a response of NG is returned to the agent i. The agent i that acquires the OK response instructs the process i, which stops the service, to end the processing. The process i performs end processing (1033). When the end processing of the process i is completed normally, the agent i returns a response of OK to the management node 700.

In this way, when the service stop processing 1022 of the process i is started, the synchronization has already ended. Therefore, time required for the synchronization is unnecessary. In the service start 1032 of the new process i, the start processing 1002 performed by using the metadata has already ended. Therefore, service may be immediately started. As a result, time required for update of a process may be substantially reduced.

The rollback processing will be explained below.

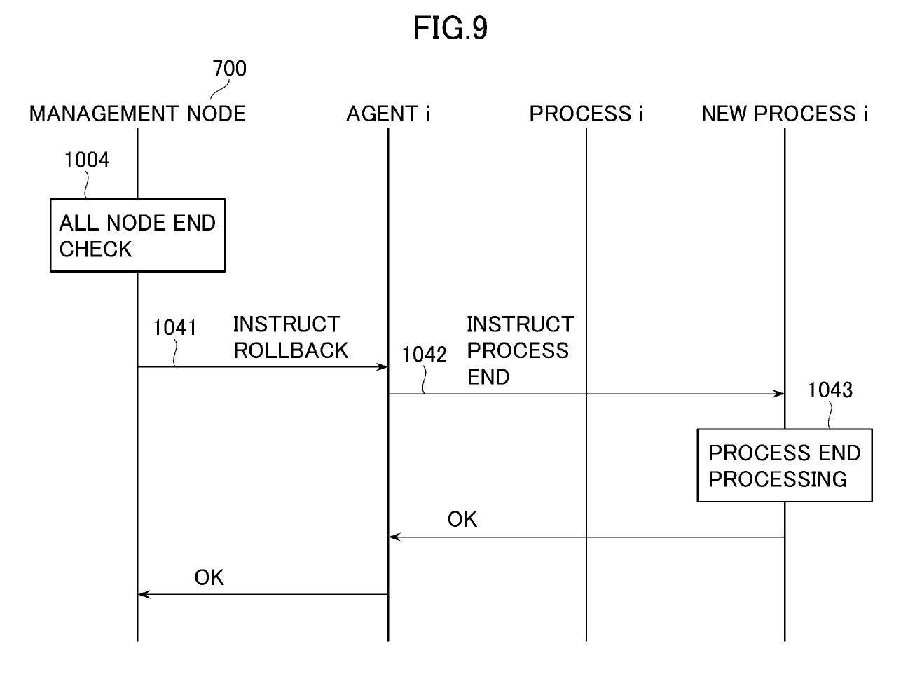

FIG. 9 illustrates an operation sequence at the time when the new process start fails. FIG. 9 illustrates rollback processing performed when a part of the nodes fails in the start of a new process or a metadata change occurs.

When it is detected that a response of NG is received from one or more agents in the all node end check (1004) after the new process start processing, the management node 700 outputs a rollback command (1041) to all agents i which are management targets. The rollback processing module processing for resetting a state to a state before a series of processes is started and, in this embodiment, processing for resetting a state to a state before the new process start processing is instructed, e.g., before the start of update. The agent i that receives the rollback command (1041) outputs a process end command (1042) to the new process i in order to end the started new process. The new process i executes process end processing (1043) and stops all kinds of processing. Thereafter, the new process i notifies the agent i that the process ends normally (OK). The agent i returns a response for notifying that the process ends normally (K) to the management node 700.

According to such processing, when the start of the new process fails in a part of the disk nodes or when a metadata change occurs, all the disk nodes are reset to the state before the update is started.

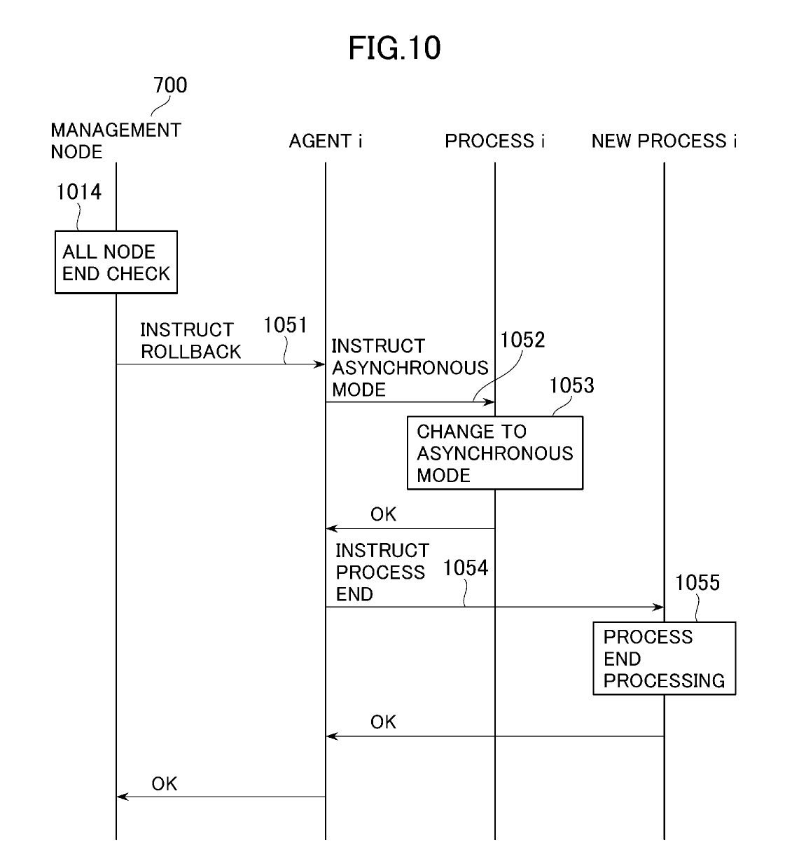

FIG. 10 illustrates an operation sequence at the time when synchronization of a process fails. FIG. 10 illustrates rollback processing performed when synchronization of a process fails in a part of the nodes or a metadata change occurs.

When it is detected that a response of NG is received from one or more agents in an all node end check (1014) after change processing to the synchronous mode, the management node 700 outputs a rollback command (1051) to all the agents i which are management targets. The agent i that receives the rollback command (1051) issues an asynchronization command (1052) in order to reset the synchronous mode to the asynchronous mode. Consequently, the writing mode in the disk of the process i currently in operation is changed to the asynchronous mode (1053). Thereafter, when it is notified to the agent i that the writing mode is changed to the asynchronous mode (OK), the agent i outputs a process end command (1054) to the new process i. The new process i executes process end processing (1055) and stops all kinds of processing. Thereafter, the new process i notifies the agent i that the process ends normally (OK). The agent i returns a response for notifying that the process ends normally (OK) to the management node 700.

According to such processing, when the synchronization of the process fails in a part of the nodes or when a metadata change occurs, all the disk nodes are reset to the state before the update is started.

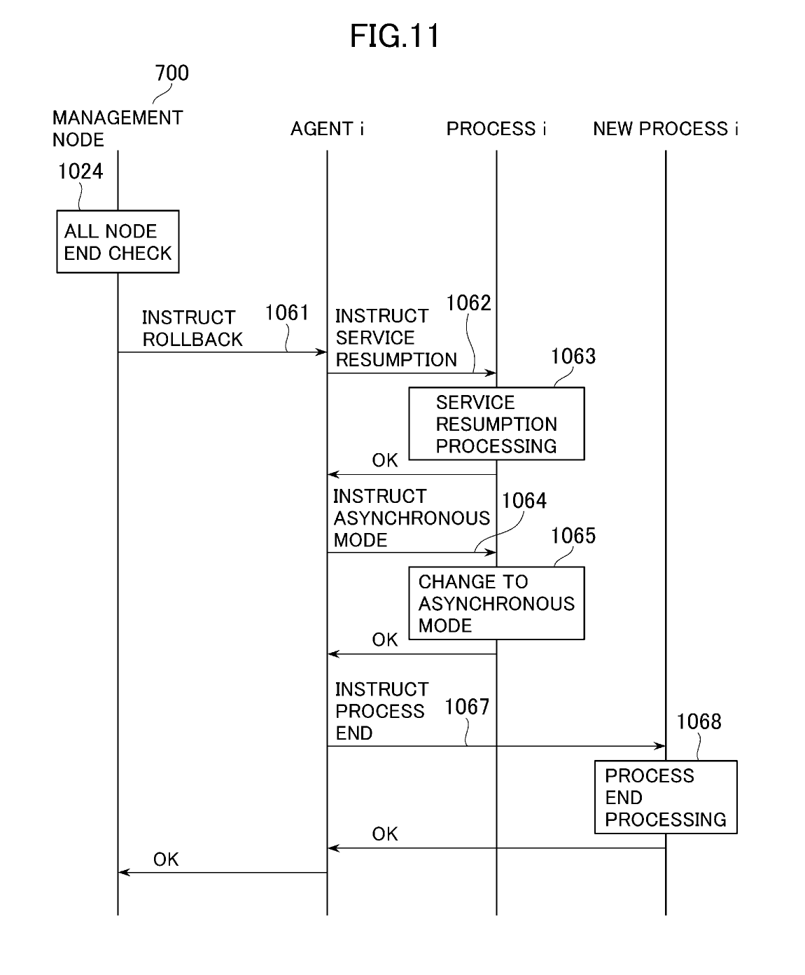

FIG. 11 illustrates an operation sequence at the time when a service stop of a process fails. FIG. 11 illustrates rollback processing performed when the service stop of the process fails in a part of the nodes or a metadata change occurs.

When it is detected that a response of NG is received from one or more agents in an all node end check (1024) after service stop processing of the process i, the management node 700 outputs a rollback command (1061) to all the agents i. The agent i that receives the rollback command (1061) instructs the process i, which stops service, to resume the service (1062). The process i executes service resumption processing (1063) and resumes the service. When it is notified from the process i that the service resumption is completed normally (OK), the agent i issues an asynchronization command (1064) and changes the writing mode to the asynchronous mode. The process i changes the writing mode to the asynchronous mode (1065). When the agent i receives a response of OK, the agent i instructs the new process i to end the process (1067). The new process i executes process end processing (1068) and stops all kinds of processing. The new process i notifies the agent i that the process ends normally (OK). The agent i returns a response for notifying that the process ends normally (OK) to the management node 700.

According to such processing, when the service stop of the process fails in a part of the nodes or when a metadata change occurs, all the disk nodes are reset to the state before the update is started.

In this way, when an error of a change of metadata occurs during the update, processing executed to that point is traced back in a reverse order to reset the disk nodes to the state before the update. Consequently, when the update is not completed, the process returns to the process and the service is continued.

A procedure of update processing of the management node and the disk nodes (agents) is explained with reference to a flowchart.

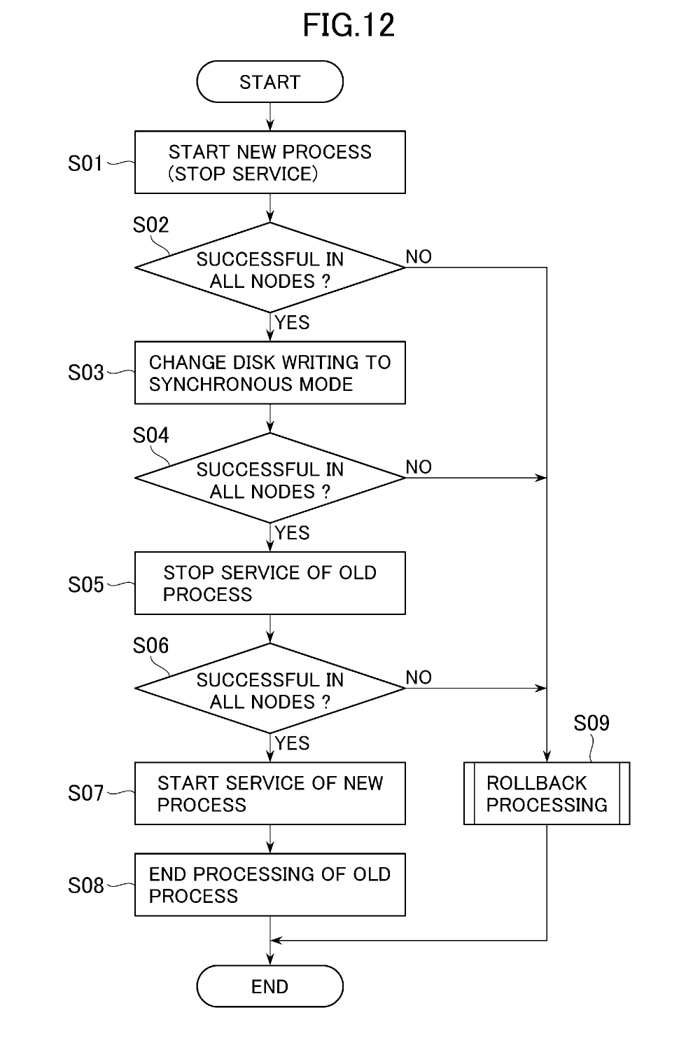

FIG. 12 is a flowchart illustrating an update processing procedure of the management node.

In response to a simultaneous update command from the system administrator or the like, the management node 700 starts processing.

[Step S01] The management node 700 transmits a new process start command to all the disk nodes as the management targets. The new process start command is a command for starting a new process in a state in which service is stopped. An agent that receives the command reads metadata and performs start processing for the new process. After becoming able to immediately start service, the agent returns a response to the management node 700.

[Step S02] The management node 700 waits for responses from all the disk nodes to which the new process start command is output. The management node 700 checks obtained responses and determines whether the new process start is successful in all the disk nodes. When the new process start is successful, the management node 700 shifts the processing to step S03. When some of the disk nodes fail in the start of the new process or a metadata change occurs and an NG response is returned, the management node 700 shifts the processing to step S09.

[Step S03] When the new process start processing ends normally, subsequently, the management node 700 instructs all the disk nodes to change the writing mode in a disk to the synchronous mode. The disk node that receives the instruction switches the writing mode to the synchronous mode and returns a response to the management node 700.

[Step S04] The management node 700 waits for responses from all the disk nodes to which the new process start command is output. The management node 700 checks obtained responses and determines whether switching to the synchronous mode is successful in all the disk nodes. When the switching to the synchronous mode is successful, the management node 700 shifts the processing to step S05. When some of the disk nodes fail in the synchronization of the process or a metadata change occurs and an NG response is returned, the management node 700 shifts the processing to step S09.

[Step S05] When the change to the synchronous mode ends normally, the management node 700 issues a command for stopping the service of the process. The disk node that receives the command instructs the process to end the process. When the process ends the process, the process returns a response to the management node 700.

[Step S06] The management node 700 waits for responses from all the disk nodes to which service stop commands for the process are output. The management node 700 checks obtained responses and determines whether the service stop of the process is successful in all the disk nodes. When the service stop is successful, the management node 700 shifts the processing to step S07. When some of the disk nodes fail in the stop of the process or a metadata change occurs and an NG response is returned, the management node 700 shifts the processing to step S09.

[Step S07] When service stop of the process ends normally, subsequently, the management node 700 instructs the disk node to start service of a new process. The disk node that receives the instruction starts the service by the new process.

[Step S08] The management node 700 instructs the disk node to end processing of the process. The disk node that receives the instruction ends the process. The management node 700 receives a response from the disk node and ends the processing.

[Step S09] When the update processing fails or a metadata change occurs, the management node 700 performs the rollback processing, resets the disk nodes to the state before the update is started, and ends the processing.

The rollback processing will be explained next.

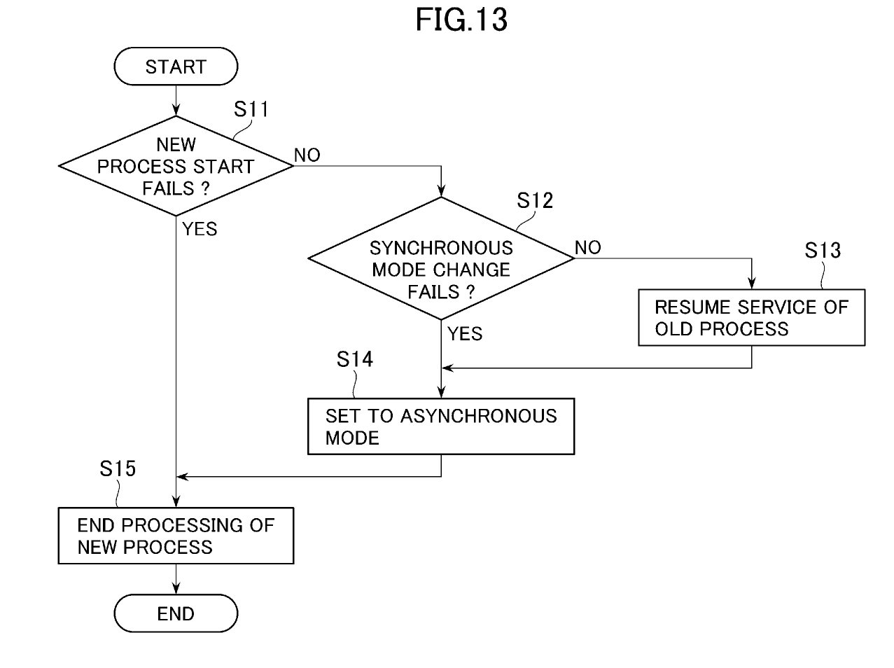

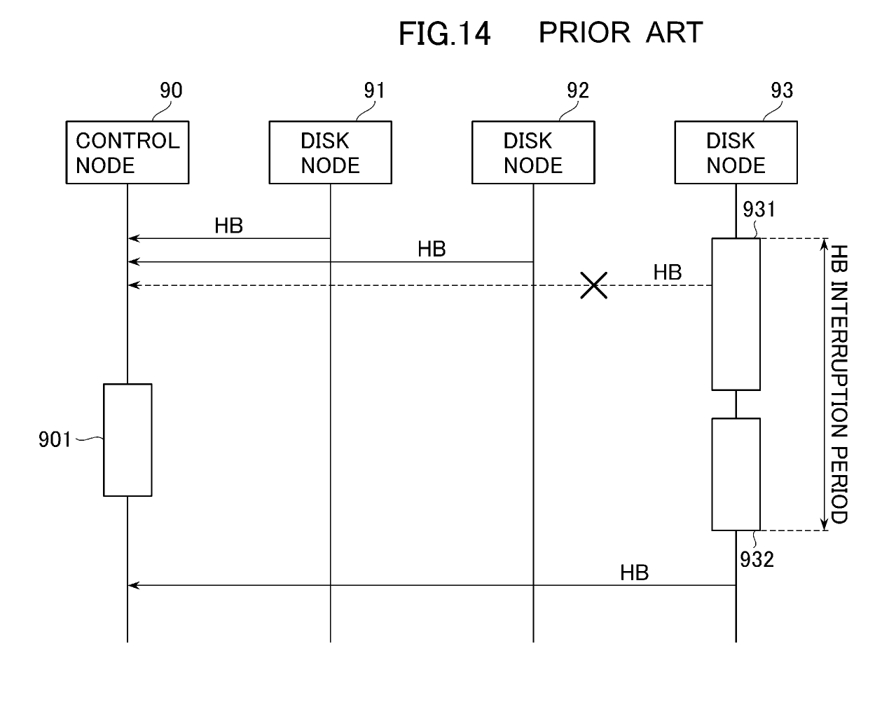

FIG. 13 is a flowchart illustrating a procedure of the rollback processing.

[Step S11] The agent i determines whether a failure occurs or not during new process start. When some of the disk nodes fail in the new process start or when a metadata change occurs, the agent i shifts the processing to step S15. Otherwise, the agent i shifts the processing to step S12.

[Step S12] The agent i determines whether a failure occurs during a change to the synchronous mode. When some of the disk nodes fail in the synchronization of the process or when a metadata change occurs, the agent i shifts the processing to step S14. Otherwise, e.g., when some of the disk nodes fail in the stop of the process or when a metadata change occurs, the agent i shifts the processing to step S13.

[Step S13] The agent i resumes the stopped service of the process.

[Step S14] The agent i resets the synchronous mode to the asynchronous mode.

[Step S15] The agent i ends the started new process.

According to the execution of the processing procedure explained above, when the update processing fails or the metadata is changed during the update processing, the executed processing is traced in a reverse order to reset the disk nodes to the state before the update start. In this way, since the disk nodes automatically return to the state before the update start, service stoppages may be reduced. For example, at a point when the change of the metadata ends, the update processing may be started again.

According to the technique disclosed above, data writing in a storage device is performed in the synchronous mode before an old process end processing. Consequently, in the process end processing, it is possible to omit the processing for writing the data, which is accumulated in the cache memory, on the disk and synchronizing the data and reduce time required for the update.

The processing functions explained above may be realized by a computer. In that case, a computer program describing processing contents of functions to be provided in the management node and the storage nodes included in the storage system is provided. When the computer program is executed by the computer, the processing functions are realized on the computer. The computer program describing the processing contents may be recorded on a computer-readable recording medium.

When the computer program is put on the market, for example, portable recording media such as a DVD (Digital Versatile Disc) and a CD-ROM (Compact Disc Read Only Memory) having the computer program recorded thereon are sold. It is also possible to store the computer program in a storage device of a server computer and transfer the computer program from the server computer to other computers via a network.

The computer that executes the computer program stores the computer program recorded in the portable recording medium or the computer program transferred from the server computer in a storage device of the computer. The computer reads the computer program from the storage device of the computer and executes processing conforming to the computer program. The computer may also directly read the computer program from the portable recording medium and execute the processing conforming to the computer program. The computer may also execute, every time the computer program is transferred from the server computer, processing conforming to the received computer program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

1. A computer-readable recording medium encoded with an update processing program containing instructions executable on a computer, the computer included in a storage system that stores data distributedly among a plurality of storage devices, the program causing the computer to execute:
a procedure in which, when a data writing request to write data to the plurality of storage devices is received, a synchronous and asynchronous instruction unit instructs a reading and writing control unit, which has
a synchronous mode for directly writing write data into the plurality of storage devices and
an asynchronous mode for accumulating the write data in a cache memory and for writing the accumulated data in the plurality of storage devices at a specific timing,
to perform data writing using either the synchronous mode or the asynchronous mode; and
a process control procedure in which a process control unit executes update processing
for controlling an operation of a process that is executing specific service processing and a new process,
for instructing, when an update is requested, the synchronization and asynchronization instructing unit to switch the reading and writing control unit, which is set in the asynchronous mode while the process is executing the service processing, to the synchronous mode,
for issuing an end instruction to the process to cause the process to end the service processing in a state in which the write data output by the process is directly written in the storage device, and
for starting service processing of the new process after the process ends the service processing.

2. The computer-readable recording medium according to claim 1, wherein, in the process control procedure, when a service by the new process is started, the synchronization and asynchronization instructing unit is instructed to switch the reading and writing control unit to the asynchronous mode.

3. The computer-readable recording medium according to claim 1,
wherein a storage area of the storage device is managed with management information in which logical segments obtained by dividing a virtual logical volume into specific storage area units are associated with slices obtained by dividing an actual data storage area of the storage device associated with the logical segments into the specific storage area units, and
wherein, in the process control procedure, before the instruction of switching to the synchronous mode, the management information distributedly stored among the plurality of storage devices is read out and the new process is started in a state in which the service processing is stopped.

4. The computer-readable recording medium according to claim 1, the program further causing the computer to execute:
a management information check procedure for collecting, at least before the start of the update processing and at the end of the update processing, management information distributedly stored among the storage devices in which logical segments obtained by dividing a virtual logical volume into specific storage area units are associated with slices obtained by dividing an actual data storage area of the storage device associated with the logical segments into the specific storage area units, comparing the management information before the start of the update processing and the management information at the end of the update processing, and notifying the process control unit whether or not the management information is changed,
wherein, in the process control procedure, the update processing is stopped when the management information is changed, and the process is reset to a state before the update processing was started.

5. The computer-readable recording medium according to claim 1, wherein, in the process control procedure, according to instructions simultaneously transmitted from a managing apparatus that manages a plurality of the computers each connected to the plurality of storage devices, to the computers, processing for causing the reading and writing control unit to operate in the synchronous mode, processing for issuing an end instruction to the process and ending the processing, and processing for starting service by the new process are executed, and an end result is notified to the management apparatus every time the processing ends to wait for a next instruction.

6. The computer-readable recording medium according to claim 5, wherein, in the process control procedure, when a rollback instruction issued by the managing apparatus when one or a plurality of the computers fail to perform processing according to the instruction is received, procedures of the update processing executed according to the instruction from the managing apparatus are traced in a reverse order to reset the process to a state before the update processing was started.

7. The computer-readable recording medium according to claim 6, the program further causing the computer to execute:
a management information check procedure for collecting, at least before start of the update processing and at end of the update processing, management information distributedly stored among the storage devices in which logical segments obtained by dividing a virtual logical volume into specific storage area units are associated with slices obtained by dividing an actual data storage area of the storage device associated with the logical segments into the specific storage area units, comparing the management information before the start of the update processing and the management information at the end of the update processing, and notifying the process control unit whether or not the management information is changed,
wherein, in the process control procedure, when a change of the management information is detected, the managing apparatus is notified that the management information is changed.

8. An update processing method for a storage system that stores data distributedly in a plurality of storage devices, the method comprising:
a procedure in which a process control unit, which controls operations of a process that executes a specific service processing and a new process, issues an instruction to accumulate write data written in the storage devices while the process is executing the specific service processing and to switch a reading and writing unit operation mode, which selects an asynchronous mode that writes the accumulated data into the storage devices at a specific timing, to a synchronous mode that writes the write data directly into the storage devices, when an update is requested;
a procedure in which a synchronization and asynchronization instructing unit issues, according to the instruction of the process control unit, an instruction for switching the asynchronous mode to the synchronous mode to the reading and writing control unit that writes, in the storage device, the write data output by the process or the new process in the synchronous mode or the asynchronous mode;
a procedure in which the process control unit issues an end instruction to the process and causes the process to end the service processing in a state in which the reading and writing control unit operates in the synchronous mode and the write data of the process is directly written in the storage devices; and
a procedure in which the process control unit starts service processing of the new process after the process ends the service processing.

9. A storage system that stores data distributedly among a plurality of storage devices, the system comprising:
a storage node including:
a reading and writing control unit which has a synchronous mode for directly writing write data in the storage devices and an asynchronous mode for accumulating the write data in a cache memory and writing the accumulated data in the storage devices at a specific timing, when a request to write data to the storage devices is received;
a synchronization and asynchronization instructing unit that instructs whether data writing is to be performed in the synchronous mode or in the asynchronous mode;
a process control unit that performs processing for controlling an operation of a process that is executing specific service processing and a new process, for instructing, according to an input instruction, the synchronization and asynchronization instructing unit to switch the reading and writing control unit, which is set in the asynchronous mode while the process is executing the service processing, to the synchronous mode, processing for issuing an end instruction to the process to cause the process to end the specific service processing in a state in which the write data output by the process is directly written in the storage device, and processing for starting service processing of the new process after the process ends the specific service processing and notifies an end result every time the processing ends; and
a management node including:
a management information storing unit that is connected to the plurality of the storage nodes via a network and stores update management information concerning a progress state of an update of the storage node having the process as an update target; and
an update managing unit that instructs, based on the update management information stored in the management information storing unit, all the storage nodes to switch to the synchronous node, instructs the storage nodes to stop the process when all the processing of the storage nodes is successful, and causes the storage nodes to start the new process and start a service by the new process when the processing of the storage nodes is successful.
